(19) United States
(12) Patent Application Publication
(10) Pub. No.: US 2002/0005122 A1
(43) Pub. Date: Jan. 17, 2002

(54) Method for cooking in and cleaning of a pyrolytically self-cleaning baking oven without separate cleaning of oven accessories and cooking vessels

(76) Inventor: Bernd Schultheis, Schwabenheim (DE)

Correspondence Address: Striker Striker & Stenby, 103 East Neck Road, Huntington, NY, 11743, US

(21) Appl. No.: 09/922,193

(22) Filed: Aug. 3, 2001

Related U.S. Application Data
(62) Division of application No. 09/564,759, filed on May 4, 2000.

(30) Foreign Application Priority Data
May 5, 1999 (DE) 199 20 493.4-16

(51) Int. Cl. A47J 37/10; A47J 43/18

(52) U.S. Cl. 99/426; 99/422

(57) ABSTRACT

The accessory for a baking oven and cooking vessel or dish for it are made from a material having sufficient temperature stability so that they can remain without damage in the baking oven during pyrolysis self-cleaning of the baking oven at a temperature of about 500° C. while the material has a linear thermal expansion coefficient that is as small as possible. The material is preferably glass, glass-ceramic or ceramic material with a linear thermal expansion coefficient of less than or equal to 3×10⁻⁶/K.

### BACKGROUND OF THE INVENTION

1. Field of the Invention

The present invention relates to an accessory or fitting for a baking oven and a cooking vessel or dish for it. This sort of accessory or fitting typically can be a broiler grid, a fat collecting dish, a baking pan or a cooking or baking dish. Typically the vessel or dish can be a riser mold, a roasting vessel, a pot or the like.

2. Prior Art

Pyrolysis self-cleaning of baking ovens is currently widespread. Overflowing and burned-on food residues are turned to ash by pyrolysis at temperatures of typically 500° C. and can subsequently be wiped out with a moist towel or rag. Currently accessories for baking ovens and cooking vessels for them, which are made from aluminum sheet, enameled steel sheet or chromium grid rods in grids, must be removed from baking ovens during the pyrolysis self-cleaning of the baking ovens, since the pyrolysis temperature would make the accessories and the cooking vessels unuseable because of strong warping and/or oxidation. Glass baking dishes may be used only up to a maximum temperature of 250° C.

Because of this aspect of the currently used baking oven accessories and vessels or dishes for them burned-on food residues on the baking oven accessories or the cooking vessels or dishes must be removed from them by hand during a separate cleaning operation. Besides the considerable time consumed and the not inconsiderable water consumption occurring in this separate cleaning process often strong abrasive means or a scrubbing sponge or steel wool must be used. As a result scratches are produced on the metal accessories or vessels, which promote burning on, for example in baking vessels in the next baking process.

Especially in commercial applications outside of private applications, e.g. in bakeries, pizza baking concerns, restaurants, etc., these special cleaning efforts for baking oven accessories and vessels are a considerable disadvantage.

### SUMMARY OF THE INVENTION

It is an object of the present invention to provide an accessory for a baking oven and a cooking vessel or dish for it which are made from materials that prevent damage to the accessory and cooking vessel or dish when it is left in the baking oven during pyrolysis self-cleaning or to eliminate the required separate cleaning process for the baking oven and cooking vessel or dish that accompanies a pyrolysis self-cleaning of a baking oven.

According to the invention, the accessory for a baking oven and the cooking vessel or dish placed on it or for it are made from a material that has a sufficiently high temperature stability at the high pyrolysis temperatures occurring during pyrolysis self-cleaning in baking ovens, e.g. at a pyrolysis temperature of about 500° C., so that the cooking vessels or dishes and the accessories can be left in the baking oven during the pyrolysis self-cleaning, and that has as small as possible a thermal linear expansion coefficient.

The baking oven accessories and cooking vessels or dishes used on them according to the invention have the advantage that they can remain in the oven during pyrolysis self-cleaning of the baking oven so that they are cleaned at the same time as the oven. A troublesome manual cleaning of the cooking residue from the accessories and vessels or dishes is thus eliminated.

The so-called baking oven accessories and cooking vessels or dishes can be used in baking ovens in private households and in commercial establishments. They can be advantageously used as tempering ovens in scientific and engineering laboratories.

According to a preferred embodiment of the invention the accessories for the baking oven and the cooking vessels or dishes for it are made from glass, glass-ceramic or ceramic material with a thermal linear expansion coefficient less than or equal to 3×10⁻⁶/K.

The glass-ceramic material used for the accessories and vessels or dishes should have a specific thermal stress of <0.25 MPa/K with a temperature stability >500° C. or of <0.23 MPa/K with a temperature stability of >550° C.

The baking dishes and baking pans are preferably formed from the foregoing type of materials.

According to a further aspect of the invention the material for the accessories and vessels or dishes for the baking oven can be a superior quartz-mixed-crystal glass-ceramic material, which can be transparent or colored, preferably dark. According to another aspect the material can be a keatite-mixed-crystal glass-ceramic material, which can be opaque, white or colored.

The high radiation permeability from above during pyrolysis heating is the essential advantage obtained by using glass-ceramic material.

According to another preferred embodiment the accessories for the baking oven can be made from a ceramic material with comparatively little surface porosity, preferably as little surface porosity as possible. This ceramic material is preferably aluminum oxide. Thus a broiler grid can be made from ceramic rods or tubes as well as dishes and pans.

According to a third preferred embodiment of the invention the accessories for the baking oven and the cooking vessels or dishes placed on them are made from a high temperature-stable metallic alloy with reduced linear thermal expansion coefficient. This metallic alloy can be a chromium-nickel alloy or an iron-nickel alloy, especially an alloy that is marketed under the tradename INVAR. This metallic material is especially suitable for broiler grids.

### BRIEF DESCRIPTION OF THE DRAWINGS

The objects, features and advantages of the invention will now be illustrated in more detail with the aid of the following description of the preferred embodiments, with reference to the accompanying figures in which:

FIG. 1 is a top perspective view of a baking dish made from a material according to the invention,

FIG. 2 is top perspective view of a baking pan with an additional partially sunken fat/baking juice collecting region; and

FIG. 3 is a top perspective view of a broiler grid comprising rods or tubes made from the materials of the invention.

### DESCRIPTION OF THE PREFERRED EMBODIMENTS

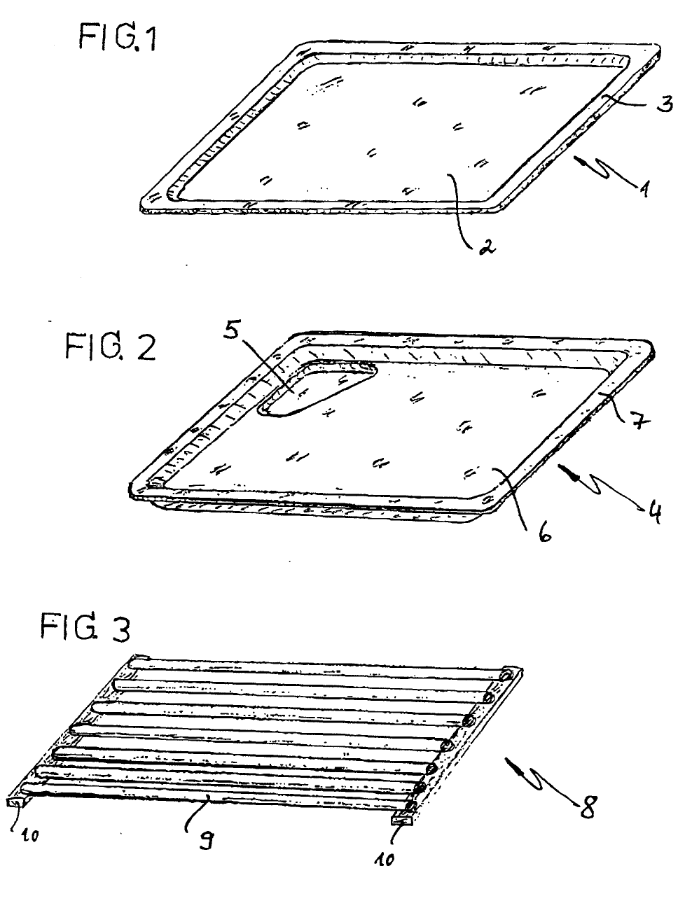

FIG. 1 is a perspective view of a baking dish 1, as it is used especially for baking cakes or the like. The baking dish t has a flat bottom portion 2 and raised peripheral edge portion 3, which has a flattened top surface. The material of the baking dish preferably is a transparent superior quartz-mixed-crystal glass-ceramic material, which is marketed under the trademark ROBAX©, or alternatively a dark colored superior quartz-mixed-crystal glass-ceramic material similar to glass-ceramic material that is marketed under the trademark CERAN©.

The baking dish 1 can be made from white opaque keatite-mixed-crystal glass-ceramic material, for example that known under the trademark CERAX®, or alternatively from colored opaque keatite-mixed-crystal glass-ceramic material.

This glass-ceramic material has a specific thermal stress of <0.23 MPa/K with a temperature stability of >550° C.

FIG. 2 is a baking pan 4 with an additional fat/baking juice collection region 5 partially sunken in the flat bottom portion 6. This baking pan 4, like the baking dish 1 according to FIG. 1, has a raised peripheral edge portion 7, which is generally more curved than in the case of the baking dish shown in FIG. 1.

The baking pan 4 shown in FIG. 2 is made preferably from a glass-ceramic material, as described in connection with FIG. 1.

Alternatively to the glass-ceramic material described in connection with FIG. 1, both the baking dish 1 and the baking pan 4 can be made from a ceramic material, for example aluminum oxide with little surface porosity.

Basically it can also comprise a high temperature-stable metallic material with a reduced linear thermal expansion coefficient.

FIG. 3 shows a broiler grid 8 with rods or tubes 9, which are attached to two frame members 10. These rods or tubes 9 and the frame members 10 are made from a ceramic material with a reduced surface porosity or from a chromium-nickel or iron-nickel alloy with reduced or slight linear thermal expansion properties.

Other accessories for baking ovens and cooking vessels or dishes can be made in the same manner as the embodiments described above.

The term “comparatively little” surface porosity means that the material is first selected according to the principal criteria, namely the thermal expansion coefficient and high temperature stability criteria, and then according to its surface porosity so that the material with the smallest surface porosity is selected while satisfying the principal criteria.

The disclosure in German Patent Application 199 20 493.4-16 of May 5, 1999 is incorporated here by reference. This German Patent Application describes the invention described hereinabove and claimed in the claims appended 20 hereinbelow and provides the basis for a claim of priority for the instant invention under 35 U.S.C. 119.

While the invention has been illustrated and described as embodied in an accessory or fitting for a baking oven and a cooking vessel or dish useable on it, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

I claim:

1. An accessory for a baking oven and a vessel for said accessory, wherein said accessory and said vessel are made from a material having sufficient temperature stability so that said accessory and said vessel can remain without damage in said baking oven during pyrolysis self-cleaning of said baking oven while said material has a linear thermal expansion coefficient that is as small as possible.

2. The accessory and the vessel as defined in claim 1, wherein said material is glass or glass-ceramic with a thermal coefficient of ≦3×10⁻⁶/K, a specific thermal stress of <0.25 MPa/K with a temperature stability of >500° C. or of a specific thermal stress of <0.23 MPa/K with a temperature stability of >550° C.

3. The accessory and the vessel as defined in claim 1, wherein said material is a high temperature stable metallic alloy.

4. The accessory and the vessel as defined in claim 2, wherein said material is a superior-quartz-mixed-crystal glass-ceramic.

5. The accessory and the vessel as defined in claim 4, wherein said glass-ceramic is transparent or colored.

6. The accessory and the vessel as defined in claim 4, wherein said glass-ceramic is dark colored.

7. The accessory and the vessel as defined in claim 1, wherein said material is a keatite-mixed crystal glass-ceramic.

8. The accessory and the vessel as defined in claim 7, wherein said glass-ceramic is opaque and white or colored.

9. The accessory and the vessel as defined in claim 1, wherein said material is a ceramic with comparatively little surface porosity and a thermal expansion coefficient of <3×10⁻⁶/K.

10. The accessory and the vessel as defined in claim 9, wherein said ceramic comprises aluminum oxide.

11. The accessory and the vessel as defined in claim 3, wherein said metallic alloy is a chromium-nickel alloy or an iron-nickel alloy.

12. The accessory and the vessel as defined in claim 9, wherein the vessel comprises a broiler grid (8) made from ceramic rods or tubes (9) with comparatively little surface porosity.

13. The accessory and the vessel as defined in claim 11, wherein the vessel comprises a broiler grid (8) made from metallic rods or tubes (9).

14. The accessory and the vessel as defined in claim 1, wherein the vessel comprises a baking dish (1).

15. The accessory and the vessel as defined in claim 1, wherein the vessel comprises a baking pan (1).

16. The accessory and the vessel as defined in claim 1, wherein said pyrolysis self-cleaning is performed at a pyrolysis temperature of about 500° C.
